(19) United States
(12) Patent Application Publication
(10) Pub. No.: US 2009/0039001 A1
(43) Pub. Date: Feb. 12, 2009

(54) ENHANCED SEPARATION TANK WITH pH CONTROL

(76) Inventor: JOSEPH MONTEITH, Toronto (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/244,472

(22) Filed: Oct. 2, 2008

Related U.S. Application Data
(63) Continuation of application No. 11/289,131, filed on Nov. 29, 2005, now abandoned.

(51) Int. Cl. C02F 1/66; C02F 103/06

(52) U.S. Cl. 210/96.1; 210/206

(57) ABSTRACT

A water-handling installation comprises a tank interceptor for receiving liquid and in which oil or suspended solids are separated from the liquid prior to discharge. The water-handling installation further comprises a pH adjustment module in fluid communication with the tank interceptor. The pH adjustment module receives a portion of liquid contained in the tank interceptor and adjusts the pH thereof prior to returning the diverted portion back to the tank interceptor.

### CROSS-REFERENCE TO RELATED APPLICATION

This application is a continuation of U.S. patent application Ser. No. 11/289,131, which was filed on Nov. 29, 2005, and entitled “ENHANCED SEPARATION TANK WITH pH CONTROL”, which is incorporated herein by reference.

### FIELD OF THE INVENTION

This invention relates generally to separator tanks or interceptors, adapted to receive primarily rainwater from a storm sewer or drain, and additionally to perform the function of separating and entrapping any oil- or gasoline-based materials and suspended solids that may enter, allowing the water fraction to discharge into municipal receiving sewers or water courses. In particular, this invention is related to separator tanks and the ability to adjust the pH of the liquid contained therein, so as to achieve a pre-determined pH set point.

### BACKGROUND OF THE INVENTION

Separator tanks are known in the art. An improved tank interceptor construction is the subject of U.S. Pat. No. 4,985,148, issued Jan. 15, 1991, and entitled, “Improved Separator Tank Construction”. This tank interceptor provides two distinct responses to two different operating conditions.

When the materials entering the interceptor include discharge from a service station, garage, machine shop, factory or the like, or oil that has spilled accidentally, these non-aqueous materials are collected within the interceptor. The aqueous fraction is allowed to leave the interceptor and pass on to a storm sewer or the like, but the liquid fraction made up of oil or fat of animal, vegetable or mineral origin, gasoline and the like remains trapped within the interceptor until the same is pumped out. Further, any heavier-than-water materials sink to the bottom of the interceptor and are confined to a particular location from where they can also be pumped out at intervals.

The interceptor is also adapted to deal with inflow resulting from heavy rain during a storm. Such inflow would typically be a combination of storm drainage from an adjacent industrial property, garage or the like, as well as inflow from storm drains adapted to catch rainwater. When peak flows during a heavy rain storm arrive at the interceptor, the interceptor automatically diverts most of this peak flow directly to an outlet opening which passes it directly to a storm sewer. Only a portion of the peak flow of the incoming rainwater is allowed through the treatment/storage chamber of the interceptor.

To accomplish the aforesaid goals, the interceptor includes a passageway extending substantially directly between the interceptor inlet and the outlet. The passageway is essentially sealed from communication with the remainder of the interior of the tank interceptor, except for an opening adjacent the inlet and an opening adjacent the outlet. Each opening communicates the passageway with the remainder of the tank interior, which may be regarded as a treatment chamber. A weir is provided within the passageway, disposed with respect to the first opening such that, under relatively low entry flow rates, all entering materials are contained by the weir and flow through the first opening and into the treatment chamber, whereas under relatively high entry flow rates, part of the entering material overflows the weir and is delivered by the passageway to the outlet.

Recognizing that it was not necessary for the entire volume inside the interceptor tank (except for the passageway) to be used as a treatment chamber, and in view of the desirability of making the passageway more fully accessible to personnel wishing to inspect the interceptor for damage, improper accumulations of materials, etc., an improved version of the separator tank was developed and is the subject of U.S. Pat. No. 5,498,331, issued Mar. 12, 1996. This interceptor includes a treatment compartment provided in the bottom portion thereof and a by-pass compartment in the top portion thereof (the latter being a convenient area where inspection personnel may stand).

More particularly, the tank interceptor includes a container having a bottom wall, a side wall and a top wall which together define an internal chamber, a partition dividing the chamber into a by-pass compartment above the partition and a treatment compartment below the partition, the partition having an upper surface. A main inlet is provided in the side wall above the partition and is adapted to permit liquid to flow into the by-pass compartment. An outlet adjacently above the upper surface is spaced away from the inlet, the outlet being adapted to permit liquid to flow out of the by-pass compartment. The upper surface of the partition is configured to include a raised portion which isolates the inlet from the outlet, the raised portion constituting a weir, such that liquid entering at the inlet and seeking to reach the outlet through the by-pass compartment must overflow the weir in order to do so. The partition has first and second openings on opposite sides of the raised portion of the upper surface of the partition, both openings communicating the by-pass compartment with the treatment compartment, and allowing liquid, without having to overflow the raised portion, to travel from the inlet to the outlet by passing through the treatment compartment. Each of the first and second openings communicates with the top of a respective vertical pipe, each pipe having a bottom end communicating with the treatment compartment.

Because it is necessary to allow personnel to inspect, clear and/or repair portions of the treatment compartment below the partition, the container of the interceptor is provided with an inspection opening in the partition, large enough to allow maintenance personnel to pass through, along with a man-hole cover adapted to close the inspection opening in a liquid-tight manner.

It was subsequently realized that the inspection opening could be realized by making one of the openings through the partition (the openings connected to the respective pipes) large enough to allow maintenance personnel to pass through and into the treatment compartment, as disclosed in U.S. Pat. No. 5,725,760, issued Mar. 10, 1998. In this interceptor, the access opening at the top of the container (allowing access to the by-pass compartment) is positioned in alignment with the large-diameter partition opening, to allow visual inspection and sampling from outside the container, and to facilitate the entry of a snorkel for the purpose of pumping out the contents of the treatment compartment.

With increasing awareness of environmental issues, especially that of industrial impacts upon environmental health, there is a continual drive towards ‘green’ technologies. While the above noted technologies are very effective in capturing oils and sediment, they are not geared to address a further important aspect of stormwater runoff, that being pH. In certain industrial environments, for example concrete production facilities, stormwater runoff can be considerably alkaline, due to aggregates stored on the sites.

Conventional practices to neutralize alkali stormwater include holding ponds or tanks and injecting hazardous hydrochloric acid (HCl) or sulfuric acid (H₂SO₄) into the stormwater prior to discharge. Employing such dangerous treatment methods raises serious concerns such as inconsistent treatment, high equipment maintenance due to the highly corrosive nature of the acids used, chemical storage issues and employee safety. A consistent, effective and safe-solution was required.

Other patents, only peripherally related to the subject matter of this specification, are as follows:

U.S. Pat. No. 4,136,010 to Pilie et al, Jan. 23, 1979;

U.S. Pat. No. 1,844,443 to Schmidt, Feb. 9, 1932;

U.S. Pat. No. 942,907 to Huff, Dec. 14, 1909;

U.S. Pat. No. 3,567,024 to McCormick, Mar. 2, 1971; and

U.S. Pat. No. 3,221,881 to Weiler et al, Dec. 7, 1965.

### SUMMARY OF THE INVENTION

Accordingly, in one aspect, there is provided a water-handling installation comprising:

a tank interceptor for receiving liquid and in which oil or suspended solids are separated from the liquid prior to discharge, and

a pH adjustment module in fluid communication with the tank interceptor, the pH adjustment module receiving a portion of liquid contained in the tank interceptor and adjusting the pH thereof prior to returning the diverted portion back to said tank interceptor.

According to another aspect, there is provided a tank interceptor for rainwater and waste-water, comprising:

a container including a bottom wall, at least one side wall and a top wall, said walls defining an internal chamber,

a partition dividing the chamber into a by-pass compartment above the partition and a treatment compartment below the partition, the partition having an upper surface,

an inlet through the side wall adjacently above said upper surface of the partition, the inlet being adapted to permit liquid to flow into the by-pass compartment,

an outlet through the side wall adjacently above the upper surface of the partition, the outlet being adapted to permit liquid to flow out of said by-pass compartment,

the upper surface of the partition being configured to include a raised portion which isolates the inlet from the outlet, while being spaced from the top wall of the container, the raised portion requiring that liquid entering through the inlet and seeking to reach the outlet through the by-pass compartment must overflow the raised portion in order to do so,

first and second openings through the partition on the inlet side and the outlet side, respectively, of the raised portion,

a first pipe commencing substantially at said first opening, extending downward therefrom, and opening into said treatment compartment at an intermediate vertical location therein,

a second pipe commencing substantially at said second opening, extending downward therefrom, and opening into said treatment compartment at an intermediate vertical location therein,

whereby said openings and pipes communicate the by-pass compartment with the treatment compartment,

the openings and corresponding pipes being such that liquid, without having to overflow said raised portion, can travel from the inlet to the outlet by passing through the first opening into the treatment compartment, thence through the treatment compartment, thence through the second opening into the by-pass compartment, thence to the outlet,

one of said openings and the corresponding pipe having an internal diameter large enough to allow passage of a maintenance worker from said by-pass compartment into said treatment compartment,

an access opening through the top wall of the container, positioned such that maintenance personnel can, without having to enter the container, pass a snorkel through the access opening and said one of the openings in the partition, in order to pump out the contents of the treatment compartment,

a pH measurement device configured to measure pH in the treatment compartment, and

a liquid suction and discharge pipe in fluid communication with the treatment compartment for diverting a portion of the liquid to a pH adjustment module for pH adjustment of the diverted liquid.

According to yet another aspect there is provided a water-handling installation, comprising:

a tank interceptor for rainwater and waste-water, comprising:

a container including a bottom wall, a side wall and a top wall, said walls defining an internal chamber,

a partition dividing the chamber into a by-pass compartment above the partition and a treatment compartment below the partition, the partition having an upper surface,

an inlet through the side wall adjacently above said upper surface of the partition, the inlet being adapted to permit liquid to flow into the by-pass compartment,

an outlet through the side wall adjacently above the upper surface of the partition, the outlet being adapted to permit liquid to flow out of said by-pass compartment,

the upper surface of the partition being configured to include a raised portion which isolates the inlet from the outlet, while being spaced from the top wall of the container, the raised portion requiring that liquid entering through the inlet and seeking to reach the outlet through the by-pass compartment must overflow the raised portion in order to do so,

first and second openings through the partition on the inlet side and the outlet side, respectively, of the raised portion,

a first pipe commencing substantially at said first opening, extending downward therefrom, and opening into said treatment compartment at an intermediate vertical location therein,

a second pipe commencing substantially at said second opening, extending downward therefrom, and opening into said treatment compartment at an intermediate vertical location therein,

whereby said openings and pipes communicate the by-pass compartment with the treatment compartment,

the openings and corresponding pipes being such that liquid, without having to overflow said raised portion, can travel from the inlet to the outlet by passing through the first opening into the treatment compartment, thence through the treatment compartment, thence through the second opening into the by-pass compartment, thence to the outlet,

one of said openings and the corresponding pipe having an internal diameter large enough to allow passage of a maintenance worker from said by-pass compartment into said treatment compartment,

an access opening through the top wall of the container, positioned such that maintenance personnel can, without having to enter the container, pass a snorkel through the access opening and said one of the openings in the partition, in order to pump out the contents of the treatment compartment,

a pH adjustment module for adjusting the pH of a liquid flow diverted from the treatment compartment of the tank interceptor, wherein the installation is configured with a pH measurement device configured to measure pH in the treatment compartment, and

a liquid suction and discharge pipe in fluid communication with the treatment compartment for diverting a portion of the liquid to the pH adjustment module for pH adjustment of the diverted liquid.

According to still yet another aspect, there is provided, for use with handling highly alkaline water runoff, utilizing a water handling installation comprising a tank interceptor and pH adjustment module, the tank interceptor having an outer wall that encloses an internal volume which is divided by a substantially horizontal partition into a treatment compartment below the partition and an overflow compartment above the partition, the pH adjustment module being in fluid communication with the treatment compartment so as to divert a flow of water from the tank interceptor and effect a pH shift by injecting CO₂ into the liquid flow,

a process comprising the following modes:

a first mode carried out by the tank interceptor in which arriving water travels through an inlet which opens through the outer wall, passes through a first opening in the partition into the treatment compartment, thence through the treatment compartment, thence upwardly through a second opening in the partition and thence to an outlet in the outer wall for discharge, and

a second mode carried out by the pH adjustment module in which upon detection of highly alkaline conditions, the pH adjustment module draws a portion of the water and effects a pH correction by injecting CO₂, thereby shifting the pH below a predetermined pH set point.

### BRIEF DESCRIPTION OF THE DRAWINGS

One embodiment is illustrated in the accompanying drawings, in which like numerals denote like parts throughout the several views, and in which:

FIG. 1 is a vertical, axial sectional view of a tank interceptor and pH adjustment module combination;

FIG. 2 is a lateral sectional view of FIG. 1, taken at the line 2-2;

FIG. 3 is a sectional view of the pH adjustment module; and

FIG. 4 is a sample treatment regimen for alkaline stormwater runoff from a representative concrete production facility.

### DETAILED DESCRIPTION OF THE EMBODIMENTS

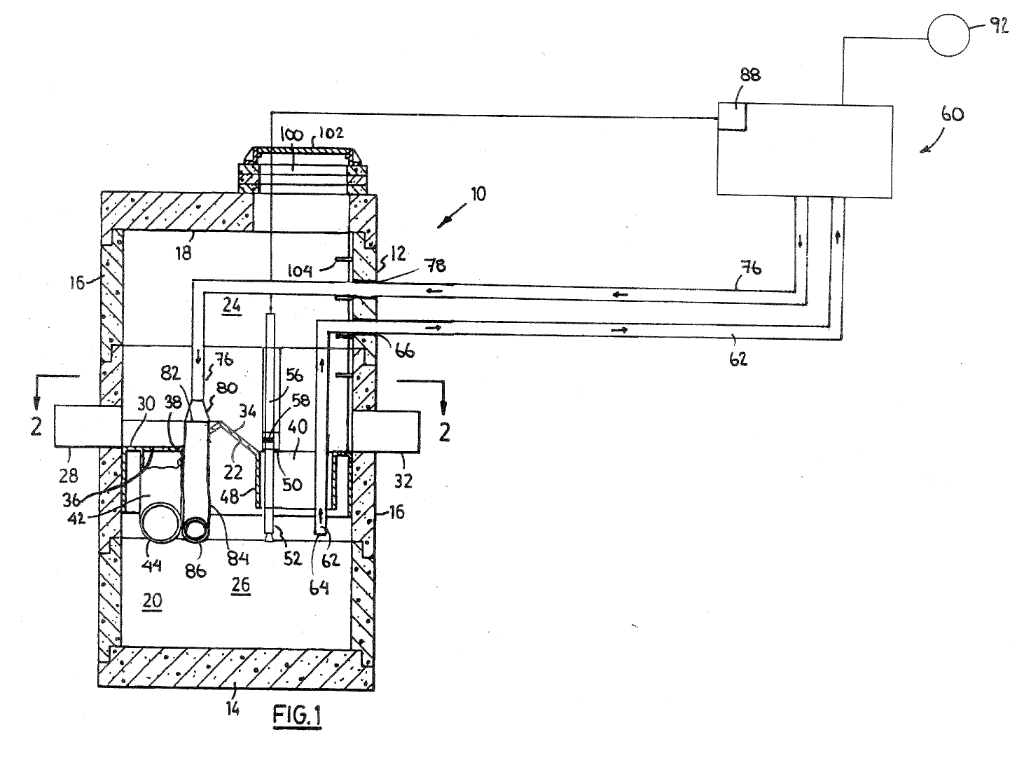

Attention is first directed to FIG. 1, in which a tank interceptor is shown generally at the numeral 10. The tank interceptor 10 includes a container 12 which has a circular bottom wall 14, a cylindrical side wall 16 (made of interlocking sections) and a substantially circular top wall 18.

The walls 14,16 and 18 define an internal chamber 20 which is divided, by a partition 22, into a by-pass compartment 24 above the partition 22, and a treatment compartment 26 below the partition 22.

An inlet 28 is provided through the side wall 16 adjacently above the upper surface 30 of the partition 22, the inlet 28 being adapted to permit liquid to flow into the by-pass compartment 24. At a peripheral location on the side wall 16 which is spaced away from the inlet 28, an outlet 32 is provided through the side wall 16 adjacently above the upper surface of the partition 22, the outlet 32 being adapted to permit liquid to flow out of the by-pass compartment 24. Typically, the outlet 32 is located slightly lower than the inlet 28, to provide a gradient that promotes flow through the tank interceptor 10.

The upper surface 30 of the partition 22 is configured in such a way as to include a raised portion 34 which isolates the inlet 28 from the outlet 32, while being spaced below the top wall 18 of the container 12. The raised portion 34 requires that liquid entering through the inlet 28 and seeking to reach the outlet 32 through the by-pass compartment 24 must overflow the raised portion 34 in order to do so.

The partition 22 exhibits a first opening 36 on the inlet side of the raised portion 34, and a second opening 40 on the outlet side of the raised portion 34. Preferably, the opening 36 is provided by an annular insert 38 which is one of several inserts having different opening sizes, to accommodate different average flow-rates or different interceptor sizes.

A first pipe 42 beginning at the opening 36, extends downward therefrom, and opens into the treatment compartment 26 at an intermediate vertical location therein. More specifically, the first pipe 42 terminates at a T-connection 44 set at right angles to the radius of the container 12, thus promoting circumferential movement of any liquid entering the compartment 26 at the bottom of the pipe 42.

A second pipe 48 commences at the second opening 40 and extends downward therefrom, opening into the treatment compartment 26 at an intermediate vertical location therein.

Thus the openings 36 and 40, along with the associated pipes 42, 48, respectively, communicate the by-pass compartment 24 with the treatment compartment 26.

It will thus be understood that the openings 36, 40 and the corresponding pipes 42, 48 are arranged such that liquid, without having to overflow the raised portion 34, can travel from the inlet 28 to the outlet 32 by passing through the first opening 36 and the associated pipe 42, thence into the treatment compartment 26, thence through the treatment compartment 26 to the bottom of the pipe 48, thence upwardly through the pipe 48 and the opening 40, thence to the outlet 32 for discharge.

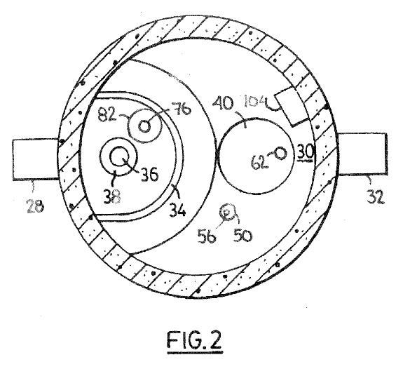

In order to permit continuous monitoring and adjustment of pH in the treatment compartment 26, an oil/inspection port 50, which rises from the surface 22, located underneath an opening 100 on the container and which is adjacent to opening 40 and raised portion 34, is used to permit passage of a pH probe 52 into this region below the partition 22 (see FIG. 2 for placement relative to opening 40 and raised portion 34). In the preferred embodiment, the pH probe is affixed to a probe extension assembly 56, so as to facilitate insertion, as well as removal for cleaning and/or replacement and calibration. To maintain the pH probe and extension assembly 56 in a fixed position, any suitable attachment means 58 may be used. In this embodiment, the attachment means 58 is a clip for affixing the pH probe and extension assembly to the sidewall of the oil/inspection port. It will be appreciated, however, that other suitable attachment means may be used, for example, friction fit couplers, threaded couplers, clamps, etc.

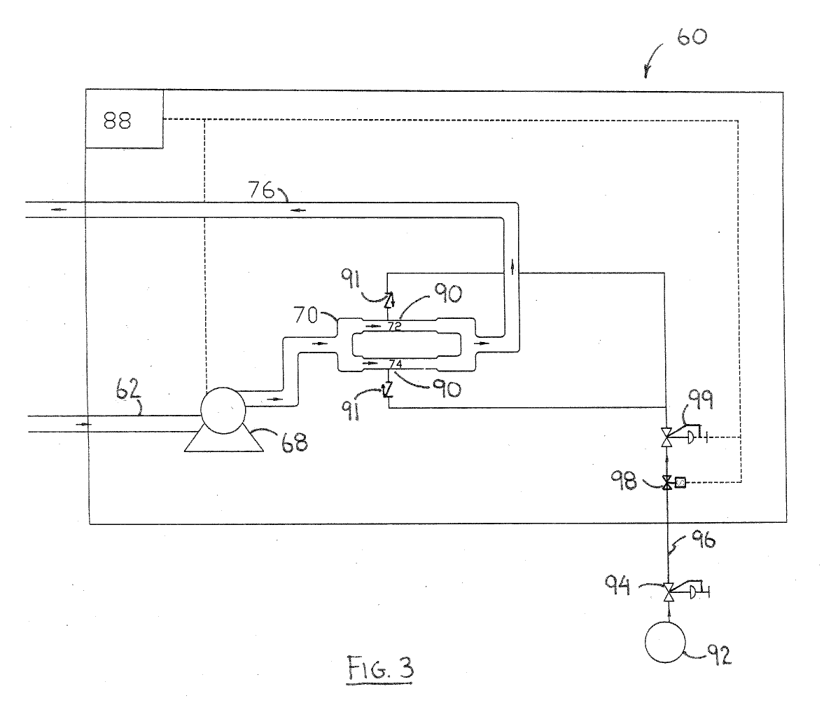

The pH of the liquid in the treatment compartment 26 is adjusted by a separate pH adjustment module, generally represented as 60 (best seen in FIG. 3). This module takes a portion of the liquid from the treatment compartment 26, subjects the extracted liquid to a pH adjustment if necessary, and returns the liquid to the treatment compartment 26, thereby effecting a pH adjustment of the liquid contained therein. To deliver liquid to the pH adjustment module, a suction pipe 62 is positioned adjacent the interior sidewall of opening 40. The open end 64 of the suction pipe preferably resides at least 2 feet under the water level (top of the outlet 32). The open end 64 may optionally be fitted with a T-connection set at right angles to the radius, so as to draw liquid from substantially a horizontal plane within the treatment compartment 26. The suction pipe 62 extends upwards as shown in FIG. 1, passes through an opening 66 in the cylindrical side wall 16 and connects to a self-priming pump 68.

While the flow of liquid can be maintained in a single conduit, in this embodiment, the liquid is directed into a manifold 70 which splits the flow into at least two streams 72, 74. Each separate flow of liquid in the manifold 70 is then subject to pH adjustment (discussed in greater detail below), after which the liquid is returned to the tank interceptor 10 via a discharge pipe 76. As shown in FIG. 1, the discharge pipe 76 enters the tank interceptor 10 by passing through an opening 78 in the cylindrical side wall 16. The discharge pipe 76 is attached via a coupler 80 to an access port 82 that extends through the partition 22 on the inlet side of the raised portion 34. The access port 82 preferably has a pipe extension 84 extending downward therefrom, opening into the treatment compartment 26 at an intermediate vertical location therein. In a preferred embodiment, the pipe extension 84 is fitted with a T-connection 86 set at right angles to the radius of the container 12, thus promoting circumferential movement of any liquid returning to the treatment compartment 26 from the pH adjustment module 60, thereby ensuring that captured sediment is not disturbed. It should be noted that in certain applications, the access port 82 and discharge pipe 76 may be of different diameters. In these circumstances, it will be appreciated that the coupler 80 can be configured to effect the necessary diametral transition. It will be further appreciated that while the access port 82 is the preferred route for returning the pH adjusted liquid, the discharge pipe 76 can be configured to return to the treatment compartment 26 via an alternate route, for example through the second opening 40.

The pH measurements registered by the pH probe 52 are transmitted to a controller 88 contained within the pH adjustment module 60. The pH adjustment module 60 continuously monitors the sensed pH and automatically activates pH adjustment relative to a preset pH point. While it will be appreciated that the pH adjustment module 60 can be used to adjust the pH either up or down, in this embodiment, the pH adjustment module 60 is used to lower the pH of basic (alkaline) liquids to below a predetermined pH set point using carbon dioxide (CO₂) injection.

As discussed above, in the pH adjustment module 60, the liquid directed into manifold 70 is split into two separate flows 72 and 74. Each separate flow of liquid in the manifold 70 is then subject to pH adjustment. This is accomplished by injecting CO₂ contained within a CO₂ cylinder 92 into each flow of liquid using Venturi injectors 90. The Venturi injectors 90 ensure high mass transfer between the CO₂ and the liquid. To prevent liquid migration up the CO₂ supply lines, check valves 91 may be fitted in place. With this arrangement, the CO₂ cylinder 92 is fitted with a primary regulator 94 that governs the initial feed pressure of CO₂ in conduit 96. The CO₂ then feeds first into solenoid valve 98 and then secondary regulator 99, both being controlled by the controller 88 of the pH adjustment module 60. Actuation of the solenoid valve 98 permits the CO₂ to flow to the Venturi injectors 90 for injection into each flow of liquid. While the solenoid valve 98 opens and closes the feed of CO₂, the secondary regulator 99 serves to control the amount of CO₂ that flows into the liquid for a given injection period. As will be readily understood by one skilled in the art, the incorporation of the CO₂ into the liquid serves to lower the pH. In fact, the use of CO₂ to reduce the pH has the added advantage of being self-buffering as the pH approaches neutral pH levels. This inherent inability to overshoot the preset pH set point is especially advantageous as it eliminates the possibility of dangerously acidic runoff being discharged from the tank interceptor 10.

In use, low-flow liquid entering at the inlet 28 is constrained by the weir (raised portion 34) to pass downwardly through the opening 36 and into the treatment compartment 26. The liquid gradually accumulates in the compartment 26 until it reaches the bottom of the pipe 48. Continuing inflow through the opening 36 gradually compresses the air located under the partition 22 (at locations other than the openings 36 and 40). Floating contaminants like oil, grease, etc. tend to accumulate under the partition 34, thus trapping them in this position and not allowing them to rise up along the larger pipe 48 to gain access to the outlet 32.

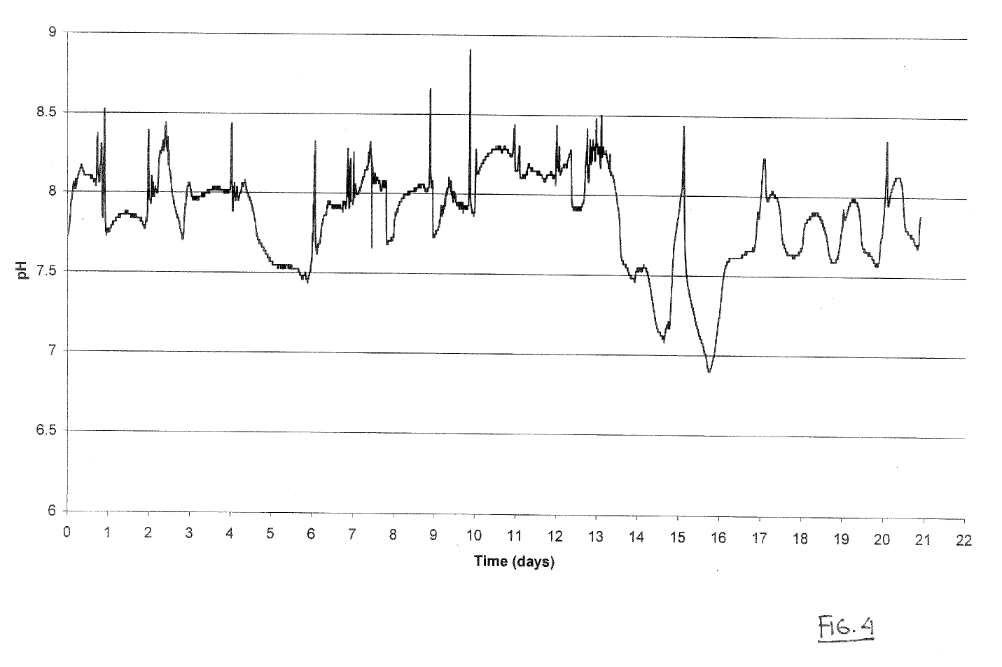

During this operation, the pH adjustment module 60 continuously monitors the pH in the treatment compartment 26 When the controller 88 detects a pH in excess of the predetermined pH set point (i.e. pH of 8.5), the controller 88 activates the self-priming pump 68, thus drawing liquid from the tank interceptor 10. Concurrently, the controller activates the solenoid valve 98, allowing CO₂ from the CO₂ source to be injected into the liquid flowing through the pH adjustment module 60, The secondary regulator 99, also controlled by controller 88 serves to control the amount of CO₂ that flows into the liquid for any given injection period. The pH adjusted water then returns to the tank interceptor, thereby imparting a pH adjustment upon the liquid contained therein. When the pH of the liquid in the treatment compartment 26 falls below the predetermined pH set point, the controller closes the solenoid valve 98 and stops the pump 68. A sample treatment regimen for alkaline stormwater runoff is shown in FIG. 4.

In the embodiment described above, the pH adjustment module 60 is maintained as a separate element from the tank interceptor. While this is a preferred embodiment, it will be appreciated that the pH adjustment module can be integrated into the construction of the tank interceptor 10.

It has been mentioned that the pH adjustment module 60 can be automated to continuously monitor and control/adjust the pH of the liquid. The pH adjustment module 60 can be further adapted with additional controls depending on the site specifics, i.e. integrated PLC controls can be used to monitor the system and relay information to a centralized reporting center, for easy operation and maintenance.

The pH adjustment module may be of the type sold by Green Turtle Technologies of Toronto, Ontario, Canada under the name PHIX™ Basic Series System. It will be appreciated, however, that any suitable CO₂ injection/treatment system could be implemented as a substitute for the above described configuration.

In the embodiment illustrated, the opening 40 (i.e. the opening on the “outlet” side of the weir constituted by the raised portion 34) has an internal diameter large enough to allow passage of a maintenance worker from the by-pass compartment 24 into the treatment compartment 26.

In FIG. 1, it will be seen that the top wall 18 of the container 12 provides the access opening 100, which is offset with respect to the axis of the circular top wall 18, such that it approximately overlies the position of the opening 40 and oil/inspection port 50. A cover and grate 102 is provided to close the access opening 100. By generally aligning the opening 100 and the oil/inspection port 50 and opening 40, it is possible to carry out inspection, sampling and the pumping out of the entire contents of the treatment compartment 26 from a position above the access opening 100, thus making it unnecessary, at least for a large number of maintenance tasks, for a worker to actually enter the container 12.

However, to facilitate the work of personnel that do need to enter the containers for cleaning and other purposes, a standard ladder 104 is anchored into the cylindrical side wall 16 of the container 12.

Although the illustrated embodiment shows the disposition of the weir constituted by the raised portion 34 to be around opening 36, i.e. the raised portion 34 may be around opening 40, simply by reconfiguring the size and disposition of the weir constituted by the raised portion 34.

It is preferred also that the upper surface 30 of the partition 22 lie substantially in a single horizontal plane.

While FIG. 1 shows the inlet and outlet to be approximately diametrally opposed, this is not critical.

While one embodiment has been illustrated in the accompanying drawings and described hereinabove, it will be evident to those skilled in the art that changes and modifications may be made therein, without department from the scope thereof, as set forth in the appended claims.

What is claimed is:

1. A water-handling installation comprising:
a tank interceptor for receiving liquid and in which oil or suspended solids are separated from the liquid prior to discharge, and
a pH adjustment module in fluid communication with the tank interceptor, the pH adjustment module receiving a portion of liquid contained in the tank interceptor and adjusting the pH thereof prior to returning the diverted portion back to said tank interceptor.

2. The installation claimed in claim 1 wherein said pH adjustment module lowers the pH of the diverted portion when the pH of the liquid contained in the tank interceptor is above a threshold level.

3. The installation claimed in claim 2 wherein the pH adjustment module injects CO₂ into the diverted portion.

4. The installation claimed in claim 3 wherein said tank interceptor is partitioned into a treatment compartment and a bypass compartment, said portion being diverted from said treatment compartment.

5. The installation claimed in claim 4 wherein said pH adjustment module includes a pH probe in said treatment compartment.

6. A tank interceptor for rainwater and waste-water, comprising:
a container including a bottom wall, at least one side wall and a top wall, said walls defining an internal chamber,
a partition dividing the chamber into a by-pass compartment above the partition and a treatment compartment below the partition, the partition having an upper surface,
an inlet through the side wall adjacently above said upper surface of the partition, the inlet being adapted to permit liquid to flow into the by-pass compartment,
an outlet through the side wall adjacently above the upper surface of the partition, the outlet being adapted to permit liquid to flow out of said by-pass compartment,
the upper surface of the partition being configured to include a raised portion which isolates the inlet from the outlet, while being spaced from the top wall of the container, the raised portion requiring that liquid entering through the inlet and seeking to reach the outlet through the by-pass compartment must overflow the raised portion in order to do so,
first and second openings through the partition on the inlet side and the outlet side, respectively, of the raised portion,
a first pipe commencing substantially at said first opening, extending downward therefrom, and opening into said treatment compartment at an intermediate vertical location therein,
a second pipe commencing substantially at said second opening, extending downward therefrom, and opening into said treatment compartment at an intermediate vertical location therein,
whereby said openings and pipes communicate the by-pass compartment with the treatment compartment,
the openings and corresponding pipes being such that liquid, without having to overflow said raised portion, can travel from the inlet to the outlet by passing through the first opening into the treatment compartment, thence through the treatment compartment, thence through the second opening into the by-pass compartment, thence to the outlet,
one of said openings and the corresponding pipe having an internal diameter large enough to allow passage of a maintenance worker from said by-pass compartment into said treatment compartment,
an access opening through the top wall of the container, positioned such that maintenance personnel can, without having to enter the container, pass a snorkel through the access opening and said one of the openings in the partition, in order to pump out the contents of the treatment compartment,
a pH measurement device configured to measure pH in the treatment compartment, and
a liquid suction and discharge pipe in fluid communication with the treatment compartment for diverting a portion of the liquid to a pH adjustment module for pH adjustment of the diverted liquid.

7. The tank interceptor claimed in claim 6, in which said one of said openings is the second opening, said access opening through the top wall of the container being generally aligned with said one of said openings.

8. The tank interceptor claimed in claim 7, in which the upper surface of the partition lies substantially in a horizontal plane except for said raised portion, said raised portion having the shape of an elongate weir.

9. The tank interceptor claimed in claim 6, in which the suction pipe is positioned to pass through the second opening to access the treatment compartment.

10. The tank interceptor claimed in claim 6, in which the discharge pipe returns liquid to the treatment compartment via an access port.

11. The tank interceptor claimed in claim 6, in which the pH measurement device is a pH probe, said probe being inserted through an oil/inspection port on the outlet side of the raised portion of the partition.

12. The tank interceptor claimed in claim 11, further comprising a pH probe extension assembly for effecting placement of the pH probe so as to allow pH measurement of the liquid contained in the treatment compartment.

13. A water-handling installation, comprising:
a tank interceptor for rainwater and waste-water, comprising:
a container including a bottom wall, a side wall and a top wall, said walls defining an internal chamber,
a partition dividing the chamber into a by-pass compartment above the partition and a treatment compartment below the partition, the partition having an upper surface,
an inlet through the side wall adjacently above said upper surface of the partition, the inlet being adapted to permit liquid to flow into the by-pass compartment,
an outlet through the side wall adjacently above the upper surface of the partition, the outlet being adapted to permit liquid to flow out of said by-pass compartment,
the upper surface of the partition being configured to include a raised portion which isolates the inlet from the outlet, while being spaced from the top wall of the container, the raised portion requiring that liquid entering through the inlet and seeking to reach the outlet through the by-pass compartment must overflow the raised portion in order to do so,
first and second openings through the partition on the inlet side and the outlet side, respectively, of the raised portion,
a first pipe commencing substantially at said first opening, extending downward therefrom, and opening into said treatment compartment at an intermediate vertical location therein,
a second pipe commencing substantially at said second opening, extending downward therefrom, and opening into said treatment compartment at an intermediate vertical location therein,
whereby said openings and pipes communicate the by-pass compartment with the treatment compartment,
the openings and corresponding pipes being such that liquid, without having to overflow said raised portion, can travel from the inlet to the outlet by passing through the first opening into the treatment compartment, thence through the treatment compartment, thence through the second opening into the by-pass compartment, thence to the outlet,
one of said openings and the corresponding pipe having an internal diameter large enough to allow passage of a maintenance worker from said by-pass compartment into said treatment compartment, and
an access opening through the top wall of the container, positioned such that maintenance personnel can, without having to enter the container, pass a snorkel through the access opening and said one of the openings in the partition, in order to pump out the contents of the treatment compartment,
a pH adjustment module for adjusting the pH of a liquid flow diverted from the treatment compartment of the tank interceptor, wherein the installation is configured with a pH measurement device configured to measure pH in the treatment compartment, and
a liquid suction and discharge pipe in fluid communication with the treatment compartment for diverting a portion of the liquid to the pH adjustment module for pH adjustment of the diverted liquid.

14. The water-handling installation claimed in claim 13, in which said one of said openings is the second opening, said access opening through the top wall of the container being generally aligned with said one of said openings.

15. The water-handling installation claimed in claim 14, in which the upper surface of the partition lies substantially in a horizontal plane except for said raised portion, said raised portion having the shape of an elongate weir, the weir.

16. The water-handling installation claimed in claim 13, in which means are provided for venting the treatment compartment to the atmosphere.

17. The water-handling installation claimed in claim 13, in which the suction pipe is positioned to pass through the second opening to access the treatment compartment.

18. The water-handling installation claimed in claim 13, in which the discharge pipe returns liquid to the treatment compartment via an access port.

19. The water-handling installation claimed in claim 13, in which the pH measurement device is a pH probe, said probe being inserted through an oil/inspection port on the outlet side of the raised portion of the partition.

20. The water-handling installation claimed in claim 19, further comprising a pH probe extension assembly for effecting placement of the pH probe so as to allow pH measurement of the liquid contained in the treatment compartment.

21. For use with handling highly alkaline water runoff, utilizing a water handling installation comprising a tank interceptor and pH adjustment module, the tank interceptor having an outer wall that encloses an internal volume which is divided by a substantially horizontal partition into a treatment compartment below the partition and an overflow compartment above the partition, the pH adjustment module being in fluid communication with the treatment compartment so as to divert a flow of water from the tank interceptor and effect a pH shift by injecting CO₂ into the liquid flow,
a process comprising the following modes:
a first mode carried out by the tank interceptor in which arriving water travels through an inlet which opens through the outer wall, passes through a first opening in the partition into the treatment compartment, thence through the treatment compartment, thence upwardly through a second opening in the partition and thence to an outlet in the outer wall for discharge, and
a second mode carried out by the pH adjustment module in which upon detection of highly alkaline conditions, the pH adjustment module draws a portion of the water and effects a pH correction by injecting CO₂, thereby shifting the pH below a predetermined pH set point.
